(19) United States
(12) Patent Application Publication
(10) Pub. No.: US 2014/0313967 A1
(43) Pub. Date: Oct. 23, 2014

(54) MULTICAST ROUTING APPARATUS IN WIRELESS MESH NETWORK AND METHOD THEREOF

(71) Applicant: ELECTRONICS AND TELECOMMUNICATIONS RESEARCH INSTITUTE, Daejeon-city (KR)

(72) Inventors: Woo-Suk CHA, Haenam-gun (KR); Seon-Tae KIM, Daejeon (KR); Jun-Keun SONG, Daejeon (KR); Mi-Sun YU, Daejeon (KR); Ji-Young KWAK, Gwangju (KR)

(73) Assignee: ELECTRONICS AND TELECOMMUNICATIONS RESEARCH INSTITUTE, Daejeon-city (KR)

(21) Appl. No.: 14/252,204

(22) Filed: Apr. 14, 2014

(30) Foreign Application Priority Data
Apr. 22, 2013 (KR) 10-2013-0044185

(51) Int. Cl. H04W 4/06

(52) U.S. Cl. CPC H04W 4/06
USPC 370/312

(57) ABSTRACT

A multicast routing apparatus in a wireless mesh network and a method thereof are disclosed. The multicast routing apparatus in the wireless mesh network includes: an information obtaining unit configured to obtain group identification (ID) information of neighboring mesh stations corresponding to the respective mesh stations; a selecting unit configured to select a multicast forwarding candidate corresponding to a candidate of the mesh stations capable of participating in forwarding multicast data packet using the group ID information; a tree generating unit configured to generate a tree corresponding to a transmission path of the multicast data packet; and a packet transmitting unit configured to transmit data packet from a transmitting mesh station to a receiving mesh station of the mesh stations using the tree.

### CROSS REFERENCE TO RELATED APPLICATION

This application claims the benefit of Korean Patent Application No. 10-2013-0044185, filed on Apr. 22, 2013, which is hereby incorporated by reference in its entirety into this application.

### BACKGROUND

1. Technical Field

The present invention relates to a multicast routing apparatus in a wireless mesh network and a method thereof, and more particularly, to a multicast routing apparatus for supporting a multicast transmission of multimedia data in real time in a group consisting of a plurality of users in a wireless mesh network, and a method thereof.

2. Description of Related Art

FIG. 1 is a diagram illustrating a structure in which data packet is transmitted to users in a group in a wireless mesh network based on Institute of Electrical and Electronics Engineers (IEEE) 802.11s.

Referring to FIG. 1, in the wireless mesh network based on IEEE 802.11s, a user terminal is connected to the mesh network via an access point (AP) and mesh stations (MSs) transmit multicast data packet to the user terminals belonging to the same group using a multicast transmission method.

An object of a multicast transmission service is to transfer the data packet to only the terminals belonging to the same group among all the terminals in a network. If all the terminals in the network belong to the same group, or members in the same group are close to each other and densely populated, it may be a good alternative to provide the multicast transmission service by a flooding method providing the data packet using a broadcast transmission service.

Korean Patent No. 10-0755709 discloses a technology related to a method for multicast routing using MPR set information capable of improving a receiving rate of data packet by causing a multi point relay (MPR) node to redundantly retransmit the data packet even when a predetermined node is moved from a tree.

However, the broadcast transmission service according to the related art is a transmission method that a safe transfer of the data packet is not secured. Particularly, when the data packet is transmitted via a multi-hop, an amount of data packet which is lost as the hop is increased is accumulated, which may cause performance degradation of an end-to-end communication via the multi-hop.

In addition, when the terminals belonging to the same group among all the terminals in the network are scattered over the entire network, the flooding method may cause the performance degradation of the entire network due to the retransmission of unnecessary data packet.

In order to solve this problem, the multicast protocol which is previously proposed generates a multicast routing path based on a tree or mesh and transmits the data packet along the multicast routing path in a unicast transmission method.

However, the unicast transmission method guarantees the safety transmission of the data packet, but causes a significant transmission delay in transmitting the data packet from the transmit terminal to all members in the group.

The missing of the data packet and the end-to-end transmission delay are performance factors which have a great effect on a real-time quality of service such as a voice or video communication in the wireless network environment.

However, the requirements of communications quality which is required by the user may not be satisfied by a single performance factor alone such as a receiving rate of data of 100% or a very short end-to-end transmission delay.

When the user performs the voice and video communications in the wireless network, he and/or her generally requires the communications quality that the user does not feel uncomfortable. To this end, a method capable of decreasing the end-to-end transmission delay instead of allowing the slight missing of the data packet, that is, a method capable of optimizing the missing of data packet and the transmission delay for the real time communication quality is demanded.

### SUMMARY

Accordingly, the present invention has been made keeping in mind the above problems occurring in the conventional art, and an object of the present invention is to provide a multicast routing apparatus capable of supporting a multicasting transmission of real time multimedia data (voice/video) in a group consisting of a plurality of users in a wireless mesh network, and a method thereof.

In accordance with an aspect of the present invention, there is provided a multicast routing method in a wireless mesh network, the method including: obtaining group identification (ID) information of neighboring mesh stations corresponding to the respective mesh stations; selecting a multicast forwarding candidate corresponding to a candidate of the mesh stations capable of participating in forwarding multicast data packet using the group ID information; generating a tree corresponding to a transmission path of the multicast data packet; and transmitting data packet from a transmitting mesh station to a receiving mesh station of the mesh stations using the tree.

In the selecting of the multicast forwarding candidate, the multicast forwarding candidate may be selected targeting a fixed mesh station having the same group ID.

In the generating of the tree, the tree may be generated by setting the transmitting mesh station as a root of the tree and setting the receiving mesh stations having the same group ID as members of the tree.

The generating of the tree may include: transmitting, by the transmitting mesh station, an initial tree packet to the receiving mesh station by a broadcast method when the data packet which is to be transmitted is present; inserting the transmitting mesh station into a child field when receiving a connection tree packet corresponding to the initial tree packet from the receiving mesh station by an unicast method; and forwarding the initial tree packet to the receiving mesh station by the broadcast method when not receiving the connection tree packet from the receiving mesh station.

The generating of the tree may include: verifying, by the receiving mesh station, whether or not the transmitting mesh station transmitting the initial tree packet is present in a selection table; discarding the initial tree packet when the transmitting mesh station is not present in the selection table; determining whether or not the transmitting mesh station is a loop using a sequence number of the initial tree packet when the transmitting mesh station is present in the selection table; recognizing the transmitting mesh station as the loop and discarding the initial tree packet when receiving the initial tree packet having the same sequence number from a neighboring transmitting mesh station; and transmitting the connection tree packet to the transmitting mesh station by the unicast method and inserting the transmitting mesh station into a parent field when the transmitting mesh station is not the loop.

The transmitting of the data packet may include: periodically transmitting, by members of the tree, tree advertising packet to notify a mesh station of own existence; selecting a next mesh station among the members of the tree transmitting the tree advertising packet; transmitting a request frame to the next mesh station by the unicast method to thereby request a registration; and transmitting a notifying frame to a before mesh station of the next mesh station to notify that the mesh station is moved from the before mesh station to the next mesh station and deleting the before mesh station.

The method may further include supporting a movement of a mobile mesh station receiving the data packet.

In accordance with another aspect of the present invention, there is provided a multicast routing apparatus in a wireless mesh network, the apparatus including: an information obtaining unit configured to obtain group identification (ID) information of neighboring mesh stations corresponding to the respective mesh stations; a selecting unit configured to select a multicast forwarding candidate corresponding to a candidate of the mesh stations capable of participating in forwarding multicast data packet using the group ID information; a tree generating unit configured to generate a tree corresponding to a transmission path of the multicast data packet; and a packet transmitting unit configured to transmit data packet from a transmitting mesh station to a receiving mesh station of the mesh stations using the tree.

The selecting unit may select the multicast forwarding candidate targeting a fixed mesh station having the same group ID.

The tree generating unit may generate the tree by setting the transmitting mesh station as a root of the tree and setting the receiving mesh stations having the same group ID as members of the tree.

The tree generating unit may transmit, by the transmitting mesh station, an initial tree packet to the receiving mesh station by a broadcast method when the data packet which is to be transmitted is present and insert the transmitting mesh station into a child field when receiving a connection tree packet corresponding to the initial tree packet from the receiving mesh station by an unicast method.

The tree generating unit may forward the initial tree packet to the receiving mesh station by the broadcast method when the transmitting mesh station does not receive the connection tree packet from the receiving mesh station.

The packet transmitting unit may periodically transmit tree advertising packet to notify a mesh station of existence of members of the tree, select a next mesh station among the members of the tree transmitting the tree advertising packet, and transmit a request frame to the next mesh station by the unicast method to thereby request a registration.

The packet transmitting unit may transmit a notifying frame to a before mesh station of the next mesh station to notify that the mesh station is moved from the before mesh station to the next mesh station and delete the before mesh station.

The apparatus may further include a supporting unit configured to support a movement of a mobile mesh station receiving the data packet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a structure in which data packet is transmitted to users in a group in a wireless mesh network based on Institute of Electrical and Electronics Engineers (IEEE) 802.11s;

FIG. 2 is a diagram schematically illustrating a multicast routing apparatus in a wireless mesh network according to an embodiment of the present invention;

FIG. 3 is a flow chart illustrating a multicast routing method in a wireless mesh network according to an embodiment of the present invention;

FIG. 4 is a diagram illustrating a situation in which a user terminal is connected to an SMS, according to an embodiment of the present invention;

FIG. 5 is a diagram illustrating an MFCS table corresponding to the situation in which the user terminal is connected to the SMS, according to an embodiment of the present invention;

FIG. 6 is a flow chart illustrating a basic processing process generating an MFC_SRT tree according to an embodiment of the present invention;

FIGS. 7 and 8 are diagrams illustrating tree based routing paths according to an embodiment of the present invention;

FIG. 9 is a diagram illustrating an environment in which data packet is transmitted according to an embodiment of the present invention;

FIG. 10 is a diagram illustrating an environment in which data packet is transmitted in a multicast routing method in a wireless mesh network according to an embodiment of the present invention; and

FIG. 11 is a diagram illustrating a process in which data packet is transmitted in a multicast routing method in a wireless mesh network according to an embodiment of the present invention.

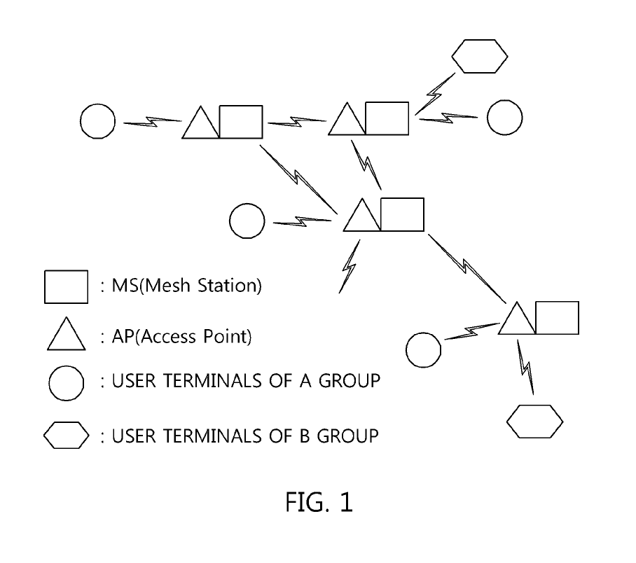

### DETAILED DESCRIPTION

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a multicast routing apparatus in a wireless mesh network and a method thereof according to preferred embodiments of the present invention will be described in detail with reference to the accompanying drawings.

First, when a multimedia multicast routing protocol (hereinafter, referred to as “MMP”) transmits data packet according to a tree based routing path (MFC based Source Rooted Tree; MFC_SRT tree) to support a real time transmission of real time data such as voice and video, it optimizes the missing of packet and an end-to-end transmission delay in the entire network by transmitting the data packet to group members included in a tree, that is, a tree member by an unicast method and by transmitting the data packet to group members who are not included in the tree by a broadcast transmission method.

The MMP corresponds to a multicast routing method in a wireless mesh network according to an embodiment of the present invention.

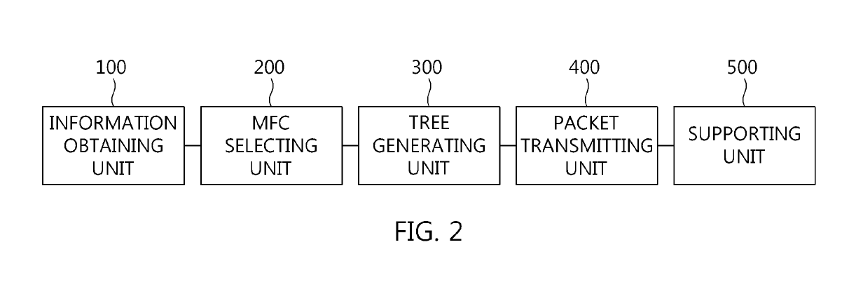

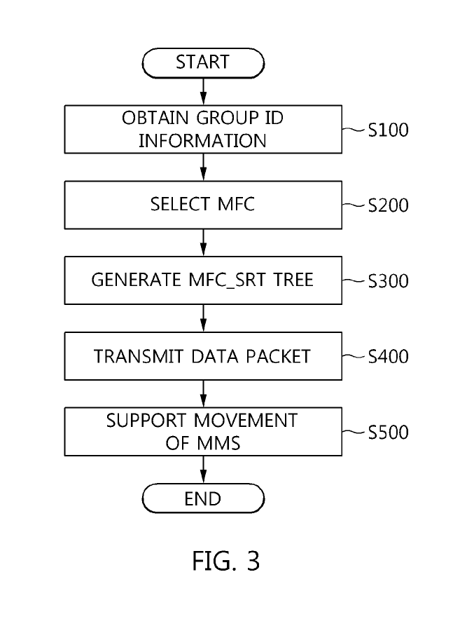

FIG. 2 is a diagram schematically illustrating a multicast routing apparatus in a wireless mesh network according to an embodiment of the present invention. In addition, FIG. 3 is a flow chart illustrating a multicast routing method in a wireless mesh network according to an embodiment of the present invention.

Referring to FIG. 2, the multicast routing apparatus in the wireless mesh network includes an information obtaining unit 100, an MFC selecting unit 200, a tree generating unit 300, a packet transmitting unit 400, and a supporting unit 500.

Referring to FIG. 3, the information obtaining unit 100 obtains group identification (ID) information of two-hop neighboring mesh stations corresponding to the respective MSs (S100). Specifically, each of a plurality of MSs may obtain the group ID information of the two-hop MSs by recording own state information (fixed MS or movable MS), one-hop neighboring terminal information, and group ID information which is in service to hello packet and periodically exchanging these information with each other.

The MFC selecting unit 200 selects a multicast forwarding candidate (hereinafter, referred to as “MFC”) which may be participated in forwarding the data packet (S200). Here, the MFC corresponds to a candidate of static mesh stations (SMSs) which may be participated in forwarding the multicast data packet.

An algorithm of selecting the MFC according to an embodiment of the present invention is similar to a process (IEEE P802.s/D1.03) of selecting a multi point relay (MPR) of radio aware optimized link state routing (RA-OLSR) according to related art. The difference is that the process of selecting the MPR of RA-OLSR according to the related art targets all MSs, but the process of selecting the MFC according to an embodiment of the present invention selects the MFC targeting the SMSs servicing the same group ID.

The tree generating unit 300 generates an MFC_SRT tree (MFC based source rooted tree) which is a transmission path of the data packet (S300). Here, a member of the MFC_SRT tree is the SMS which is selected as the MFC.

The packet transmitting unit 400 transmits the data packet from a transmitting MS to a receiving MS through the MFC_SRT tree generated by the tree generating unit 300 (S400).

The supporting unit 500 supports a movement of a mobile MS (MMS) which is receiving the multicast data packet (S500).

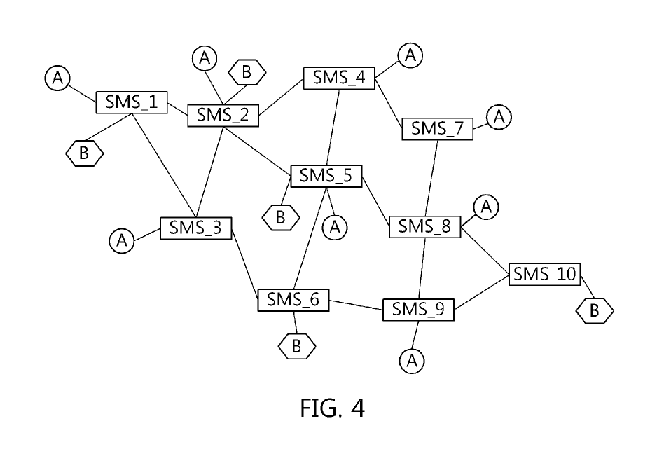

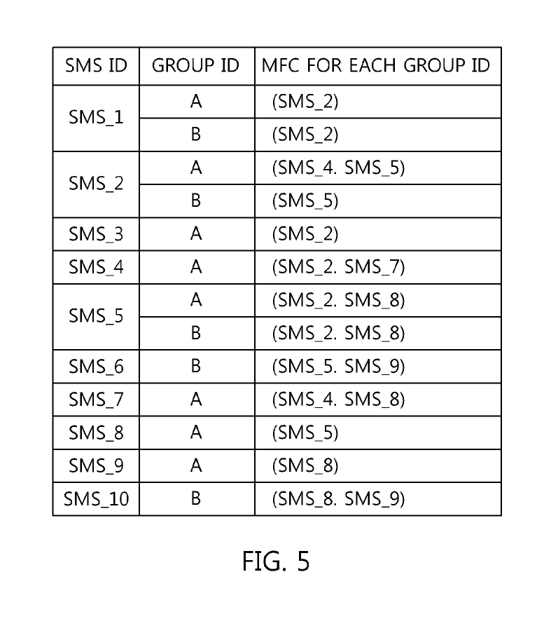

Next, a situation in which a user terminal is connected to the SMS in an environment using the multicast routing method (MMP) in the wireless mesh network and MFC table information corresponding to the situation will be described in detail with reference to FIGS. 4 and 5.

FIG. 4 is a diagram illustrating a situation in which a user terminal is connected to an SMS, according to an embodiment of the present invention. In addition, FIG. 5 is a diagram illustrating an MFC selector (MFCS) table corresponding to the situation in which the user terminal is connected to the SMS, according to an embodiment of the present invention.

For example, FIG. 4 illustrates a situation in which eight user terminals corresponding to an A group and five user terminals corresponding to a B group in the mesh network including ten SMSs are connected to the SMSs. In this situation, the MFC table information maintained by the respective SMSs is as in FIG. 5.

First, in the multicast routing method (MMP), the SMS is a fixed MS. Here, the SMS may be selected as the MFC to become a member of the MFC_SRT tree and may include a function capable of forwarding the data packet. On the other hand, in the multicast routing method (MMP), the MMS is a movable MS. Here, the MMS may not be selected as the MFC and may not become the member of the MFC_SRT tree.

The tree generating unit 300 generates the MFC_SRT tree (S300) by setting the transmitting SMS as a root of the tree and setting the receiving SMSs supporting the same group ID as the member of the tree before the transmitting SMS transmits the multicast data packet (S400), using the MFC information corresponding to the MFC selected by the MFC selecting unit 200. Here, the SMSs constituting the MFC_SRT tree are referred to as MFC_SRT tree members.

As in S300, an object of generating the MFC_SRT tree is to minimize the number of SMSs while transmitting the data packet to all members, that is, all the user terminals included in the group. Here, the minimizing of the number of SMSs means that the number of SMSs actually forwarding the data packet is minimized. Consequently, it is possible to minimize the number of times of forwarding unnecessary data packet.

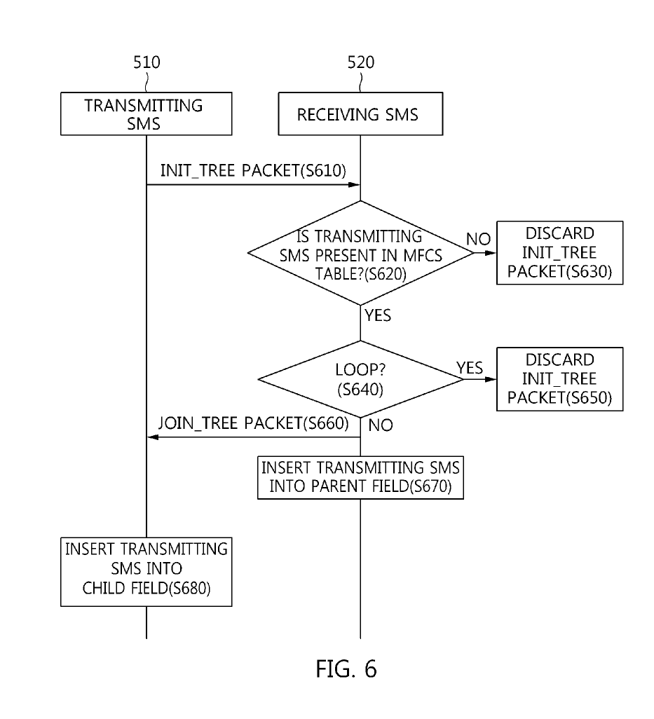

The MFC_SRT tree means the multicast routing path in which the data packet is actually transmitted. A basic processing process generating the MFC_SRT tree described above will be described in detail with reference to FIG. 6.

FIG. 6 is a flow chart illustrating a basic processing process generating an MFC_SRT tree according to an embodiment of the present invention.

Referring to FIG. 6, when the data packet to be transmitted is present, the transmitting SMS transmits INIT_TREE packet to the receiving SMS by the broadcast method and awaits a response of the JOIN_TREE packet (S610).

The SMS (hereinafter, referred to as “receiving SMS”) receiving the INIT_TREE packet verifies whether or not the transmitting SMS transmitting the INIT_TREE packet is present in the MFCS table as in FIG. 4 (S620).

When the transmitting SMS is not present in the MFCS table, the receiving SMS discards the INIT_TREE packet (S630) because the transmitting SMS transmitting the INIT_TREE packet is not the MFCS of the receiving SMS.

When the transmitting SMS is present in the MFCS table, the receiving SMS verifies whether or not it is a loop using a sequence number of the INIT_TREE packet (S640).

The receiving SMS records the sequence number of the INIT_TREE packet which is initially received from the transmitting SMS. When the receiving SMS receives the INIT_TREE packet having the same sequence number from a neighboring SMS, the receiving SMS recognizes the loop and discards the INIT_TREE packet (S650).

When it is not loop, the receiving SMS transmits the JOIN_TREE packet to the transmitting SMS by the unicast method (S660) and inserts the transmitting SMS into a parent field of a tree table (S670).

When the transmitting SMS does not receive the response of the JOIN_TREE packet, it forwards the INIT_TREE packet by the broadcast method and again awaits the response of the JOIN_TREE packet.

When the transmitting SMS receives the JOIN_TREE packet, it inserts the SMS transmitting the JOIN_TREE packet into a child field of the tree table (S680).

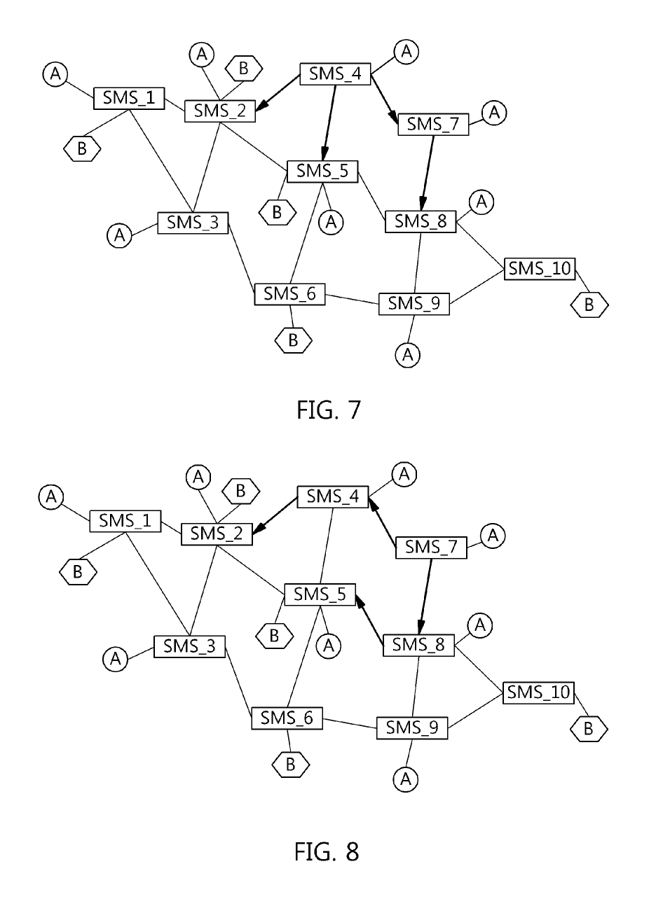

Next, a tree based routing path (MFC based source rooted tree; MFC_SRT tree) according to an embodiment of the present invention will be described in detail with reference to FIGS. 7 and 8.

FIGS. 7 and 8 are diagrams illustrating tree based routing paths according to an embodiment of the present invention.

Bold solid line arrows in FIGS. 7 and 8 indicate MFC_SRT trees generated before SMS_{—}4 and SMS_{—}7 transmit the data packet when the SMS_{—}4 and the SMS_{—}7 have the data packet which is to be transmitted to the members of the A group.

Referring to FIG. 7, a root in the MFC_SRT tree is the SMS_{—}4. SMS_{—}2, SMS_{—}5, SMS_{—}7, and SMS_{—}8, which are the members of the MFC_SRT tree, serve to forward the data packet. In addition, because the remaining SMS_{—}1, SMS_{—}3, and SMS_{—}9 belong to an A user group, but are not the members of the MFC_SRT tree, they are the members of group which do not forward the data packet but simply only receive the data packet.

When the generation of the MFC_SRT tree is completed by the tree generating unit 300 in S300, it means that a routing path in which the data packet is to be transmitted is prepared.

Then, the packet transmitting unit 400 transmits the data packet transmitted from the transmitting SMS via a path of the MFC_SRT tree.

In order to maintain the MFC_SRT tree, the transmitting SMS periodically forwards the INIT_TREE packet for each a set period (Tupdate_tree) and each SMS updates the tree table information.

The MFC_SRT tree is maintained during a period in which the data packet to be transmitted to the transmitting SMS is present. On the other hand, the MFC_SRT tree is released when the data packet to be transmitted is not present.

The multicast routing method (MMP) according to an embodiment of the present invention provides a data packet forwarding method capable of minimizing the missing of the data packet, decreasing the end-to-end transmission delay, and transmitting, by the transmitting SMS, the data packet to all the members of the group in order to support real time property of real time data such as voice and video.

Specifically, according to the multicast routing method (MMP), each SMS may transmit the data packet by the unicast method or the broadcast method depending on a structure and a role of the MFC_SRT tree.

According to the multicast routing method (MMP), the unicast method of the transmitting methods is used to safely transmit the data packet to all the members of the MFC_SRT tree via a multi-hop while minimizing the missing of the data packet. That is, when the parent SMS transmits the data packet to the child SMS in the MFC_SRT tree, it transmits the data packet by the unicast method.

In addition, according to the multicast routing method (MMP), the broadcast method of the transmitting methods is used to transmit the data packet to all the user group members while decreasing the end-to-end transmission delay. For example, when the SMS of the same group, which is not the member of the MFC_SRT tree, is present among one-hop neighboring SMSs, the data packet is transmitted by the broadcast method. This method may further improve performance when the SMSs of the group are densely positioned.

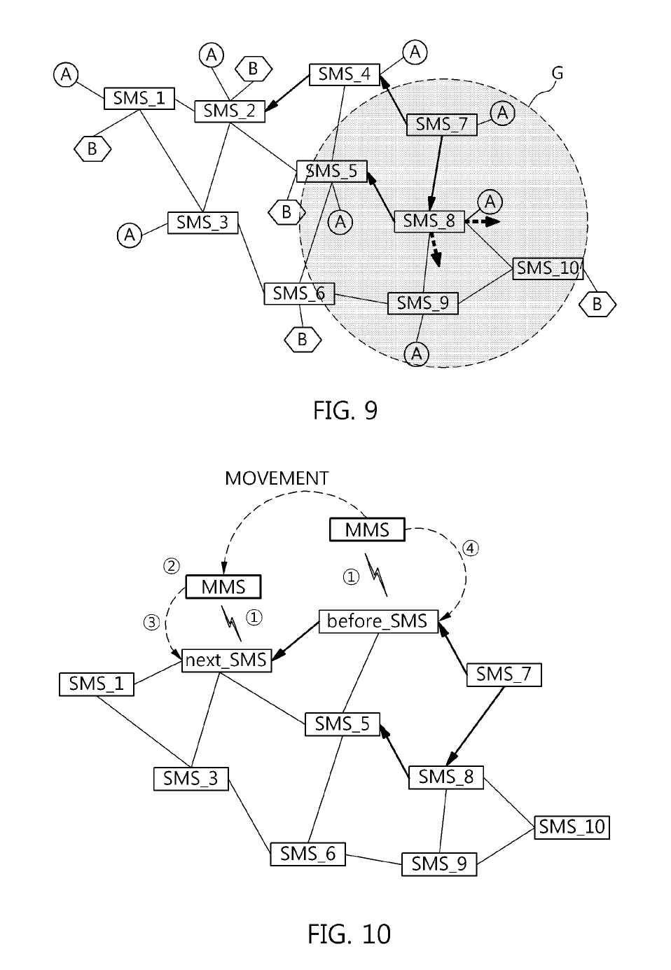

Next, an environment in which the data packet is transmitted through the routing path when the generation of the MFC_SRT tree is completed by the tree generating unit 300 in S300, will be described in detail with reference to FIG. 9.

FIG. 9 is a diagram illustrating an environment in which data packet is transmitted according to an embodiment of the present invention.

First, the environment in which the data packet is transmitted as shown in FIG. 9 is based on the tree based routing path as shown in FIG. 8.

Referring to FIG. 9, a root in the MFC_SRT tree is the SMS_{—}7. Since the SMS_{—}7 has own child SMSs, which are all own one-hop neighboring SMSs, it transmits the data packet to the SMS_{—}4 and the SMS_{—}8 by the unicast method. Next, since the SMS_{—}8 has own child SMS, which is the SMS_{—}5, it transmits the data packet to the SMS_{—}5 by the unicast method.

The SMS_{—}7 transmits the data packet to the same group (G in FIG. 9), which is not the members of the MFC_SRT tree, by the broadcast method.

Additionally, since the SMS_{—}10 receives the data packet transmitted by the SMS_{—}8, which is not the data packet of the group serviced by the SMS_{—}10, it discards the received data packet.

As described above, the multicast routing method (MMP) classifies the MS into the following two kinds to support efficient group communications of real time data in an ad-hoc network in which a static environment and a mobile environment are mixed as in the wireless mesh network.

\textcircled{1} A mobile MS (MMS), which is a movable MS, can not be selected as the MFC and can simply only receive the real time data.

\textcircled{2} CD A static MS (SMS), which is an always fixed MS, can be selected as the MFC to be participated in the MFC_SRT tree and forward data.

The mesh station (MS) may set own state to a movable state or an always fixed state when it is initialized and can change own state anytime.

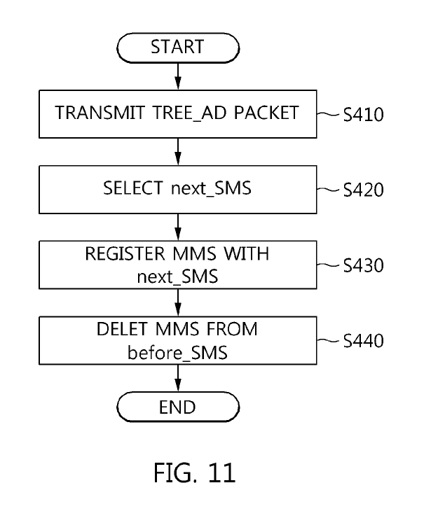

Next, a process in which an movement of the MMS is recognized in the MFC_SRT tree when the MS is moving and a process in which the data packet is transmitted will be described in detail with reference to FIGS. 10 and 11.

FIG. 10 is a diagram illustrating an environment in which data packet is transmitted in a multicast routing method in a wireless mesh network according to an embodiment of the present invention. In addition, FIG. 11 is a diagram illustrating a process in which data packet is transmitted in a multicast routing method in a wireless mesh network according to an embodiment of the present invention.

Referring to FIG. 10, before_SMS means a member of the MFC_SRT tree in which the MMS is current registered and next_SMS means a member of the MFC_SRT tree in which the MMS is moved and is subsequently registered.

Referring to FIG. 11, the respective members of the MFC_SRT tree periodically transmit TREE_AD (TREE_ADvertisement) packet to notify the MMS of own existence (S410). For example, the before_SMS of FIG. 10 periodically transmits the TREE_AD packet as in reference numeral \textcircled{1} of FIG. 10 to notify the MMS of own existence.

The MMS records the TREE_AD packets received from the members of the MFC_SRT tree and strengths of the received signals of the packets and compares the strengths of the received signals of the TREE_AD packets when a next_SMS selection period (e.g., a period in which the TREE_AD packet is transmitted*3) is elapsed to thereby select the SMS transmitting the TREE_AD packet corresponding to the strongest strength of the received signal as the next_SMS (reference numeral \textcircled{2} in FIG. 10) (S420).

The MMS transmits a MMS_REG_REQ frame to the next_SMS selected in S420 by the unicast method (reference numeral \textcircled{3} in FIG. 10), notifies the next_SMS of own movement and requests a MMS registration to the next_SMS (S430). Next, the next_SMS registers the MMS with the MMS table to correspond to the request received from S430 and transmits the MMS_REG_RES frame corresponding to a registration result to the MMS, thereby notifying the MMS of the registration.

Next, the MMS completes the registration with the next_SMS as in S430 and then transmits a MMS_REM_NOTIFY frame to the before_SMS corresponding to a before SMS (reference numeral \textcircled{4} in FIG. 10) to thereby notify own movement and request a MMS deletion (S440).

In accordance with the present invention, the multicast routing apparatus in the wireless mesh network and the method thereof may satisfy the communication quality requirements required by the voice/video group communication between the members of the group in the wireless mesh network by decreasing the end-to-end transmission delay due to the unicast transmission instead of allowing the packet missing due to the broadcast transmission of the data packet.

Further, in accordance with the present invention, the multicast routing apparatus in the wireless mesh network and the method thereof may support the real time voice/video group communication in the ad-hoc network environment and may further improve the performance as compared with the multicast routing method according to the related art in the case in which the terminals are densely distributed.

As described above, the preferred embodiments of the present invention have been disclosed. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A multicast routing method in a wireless mesh network, the method comprising:
obtaining group identification (ID) information of neighboring mesh stations corresponding to the respective mesh stations;
selecting a multicast forwarding candidate corresponding to a candidate of the mesh stations capable of participating in forwarding multicast data packet using the group ID information;
generating a tree corresponding to a transmission path of the multicast data packet; and
transmitting data packet from a transmitting mesh station to a receiving mesh station of the mesh stations using the tree.

2. The method of claim 1, wherein in the selecting of the multicast forwarding candidate, the multicast forwarding candidate is selected targeting a fixed mesh station having the same group ID.

3. The method of claim 1, wherein in the generating of the tree, the tree is generated by setting the transmitting mesh station as a root of the tree and setting the receiving mesh stations having the same group ID as members of the tree.

4. The method of claim 3, wherein the generating of the tree includes:
transmitting, by the transmitting mesh station, an initial tree packet to the receiving mesh station by a broadcast method when the data packet which is to be transmitted is present;
inserting the transmitting mesh station into a child field when receiving a connection tree packet corresponding to the initial tree packet from the receiving mesh station by an unicast method; and
forwarding the initial tree packet to the receiving mesh station by the broadcast method when not receiving the connection tree packet from the receiving mesh station.

5. The method of claim 4, wherein the generating of the tree includes:
verifying, by the receiving mesh station, whether or not the transmitting mesh station transmitting the initial tree packet is present in a selection table;
discarding the initial tree packet when the transmitting mesh station is not present in the selection table;
determining whether or not the transmitting mesh station is a loop using a sequence number of the initial tree packet when the transmitting mesh station is present in the selection table;
recognizing the transmitting mesh station as the loop and discarding the initial tree packet when receiving the initial tree packet having the same sequence number from a neighboring transmitting mesh station; and
transmitting the connection tree packet to the transmitting mesh station by the unicast method and inserting the transmitting mesh station into a parent field when the transmitting mesh station is not the loop.

6. The method of claim 1, wherein the transmitting of the data packet includes:
periodically transmitting, by members of the tree, tree advertising packet to notify a mesh station of own existence;
selecting a next mesh station among the members of the tree transmitting the tree advertising packet;
transmitting a request frame to the next mesh station by the unicast method to thereby request a registration; and
transmitting a notifying frame to a before mesh station of the next mesh station to notify that the mesh station is moved from the before mesh station to the next mesh station and deleting the before mesh station.

7. The method of claim 1, further comprising supporting a movement of a mobile mesh station receiving the data packet.

8. A multicast routing apparatus in a wireless mesh network, the apparatus comprising:
an information obtaining unit configured to obtain group identification (ID) information of neighboring mesh stations corresponding to the respective mesh stations;
a selecting unit configured to select a multicast forwarding candidate corresponding to a candidate of the mesh stations capable of participating in forwarding multicast data packet using the group ID information;
a tree generating unit configured to generate a tree corresponding to a transmission path of the multicast data packet; and
a packet transmitting unit configured to transmit data packet from a transmitting mesh station to a receiving mesh station of the mesh stations using the tree.

9. The apparatus of claim 8, wherein the selecting unit selects the multicast forwarding candidate targeting a fixed mesh station having the same group ID.

10. The apparatus of claim 8, wherein the tree generating unit generates the tree by setting the transmitting mesh station as a root of the tree and setting the receiving mesh stations having the same group ID as members of the tree.

11. The apparatus of claim 10, wherein the tree generating unit: transmits, by the transmitting mesh station, an initial tree packet to the receiving mesh station by a broadcast method when the data packet which is to be transmitted is present and inserts the transmitting mesh station into a child field when receiving a connection tree packet corresponding to the initial tree packet from the receiving mesh station by an unicast method.

12. The apparatus of claim 11, wherein the transmitting mesh station forwards the initial tree packet to the receiving mesh station by the broadcast method when the transmitting mesh station does not receive the connection tree packet from the receiving mesh station.

13. The apparatus of claim 10, wherein the packet transmitting unit: periodically transmits tree advertising packet to notify a mesh station of existence of members of the tree, selects a next mesh station among the members of the tree transmitting the tree advertising packet, and transmits a request frame to the next mesh station by the unicast method to thereby request a registration.

14. The apparatus of claim 13, wherein the packet transmitting unit transmits a notifying frame to a before mesh station of the next mesh station to notify that the mesh station is moved from the before mesh station to the next mesh station and deletes the before mesh station.

15. The apparatus of claim 8, further comprising a supporting unit configured to support a movement of a mobile mesh station receiving the data packet.
